(19) United States
(12) Patent Application Publication
(10) Pub. No.: US 2013/0164704 A1
(43) Pub. Date: Jun. 27, 2013

(54) DENTAL ARTICULATOR AND DENTAL MODEL FIXING PIN USED FOR THE SAME

(71) Applicant: Yun soon KIM, Duluth, GA (US)

(72) Inventor: Yun soon KIM, Duluth, GA (US)

(21) Appl. No.: 13/355,975

(22) Filed: Jan. 23, 2012

(30) Foreign Application Priority Data
Dec. 23, 2011 (KR) 10-2011-0141394

(51) Int. Cl. A61C 11/08; A61C 11/02

(52) U.S. Cl. 433/57; 433/60

(57) ABSTRACT

Provided is a dental articulator and a dental model fixing pin used for the same. The dental articulator has a base member for molding a dental model for a patient. The base member includes a protrusion bed that is formed on a top face of the base member along a central line in a lengthwise direction of the base member, comes into contact with a plaster dental model placed on the top face of the base member, and has a predetermined height, length, and width. The protrusion bed includes a plurality of pin fixing holes in a middle portion thereof, the plurality of pin fixing holes being spaced apart from one another at regular intervals and passing through an interior of the base member.

### BACKGROUND OF THE INVENTION

1. Field of the Invention

The present invention relates, in general, to a dental articulator and a dental model fixing pin used for the same, and, more particularly, to a dental articulator in which a protrusion bed is formed in the middle portion of a top face of a base member to which a molded dental model is coupled, and pin fixing holes having a tapered shape are formed in a middle portion of the protrusion bed, capable of easily separating a die (or a partial dental model) from the base member and conveniently re-coupling the separated die, and a dental model fixing pin used for the same.

2. Description of the Related Art

Generally, dental articulators are dental instruments that are intended to provide reliable dental prostheses such as dentures and crowns by realizing a dental structure and temporomandibular movement of a patient to check a maxillomandibular structure, occlusion and mastication in order to obtain the dental prostheses optimized to the dental structure of the patient at dental clinics and laboratories.

These dental articulators are divided into partial types (quadrant and anterior) and full-arch types according to a dental model of a patient whose teeth need to be treated, and are fabricated and used as such.

The dental articulators have been made of metal so as to be used in a firm and semi-permanent way. The metal articulators are each designed so that maxillary and mandibular articulators are coupled to each other. For this reason, the metal articulators have low workability, heavy weight, difficult operation and usage, and are expensive. To overcome such drawbacks of the metal articulators, disposable articulators formed of plastic have recently proliferated.

Such disposable plastic articulators are configured so that pin holes, into which pins can be inserted, are typically formed in the top surface of a base member acting as a basic mold, or so that a pin structure integrally protrudes from the base member in order to reduce the inconvenience of inserting the pins that have been made separately.

The present invention relates to an articulator that is used by inserting metal pins into pin holes formed in the top surface of a base member. Hereinafter, the following description will be made only to the articulator of the technical field within which the present invention falls.

In detail, in the case of the articulator using pins, the pins are inserted into a plurality of pin holes formed in the top surface of a base member at regular intervals, and then a dental model molded of dental plaster using a dental impression for a patient is placed on the top surface of the base member into which the pins are inserted. The dental model is hardened, so that a dental model for the patient is obtained.

When the dental model is molded on the base member, the dental plaster flows down an outer circumferential surface of the base member. Thus, a process is carried out of grinding the plaster flowing down the outer circumferential surface of the base member to clean the outer circumferential surface of the base member after making the mold of the dental model, and then a process of sawing the integrally molded dental model to separate a partial dental model corresponding to the teeth to be treated.

Here, the partial dental model (hereinafter, referred to as a “die”), which is separated from the adjacent dental model by the sawing and is used for treatment, does not easily separate from the base member even if the process of sawing is used to separate the die from the entire dental model, because a bottom surface of the die is fixed to the top surface of the base member and the pins are coupled to the base member.

Thus, to separate the die, which is disconnected from the adjacent dental model for the purpose of treatment, from the base member, the process is carried out of inserting a pointed tool between the dental model, which is of hardened plaster, and the base member, and a process of separating the die fixedly attached to the top surface of the base member.

In this case, when the die is separated from the base member, the die does not easily separate because the bottom surface of the cut die is in close contact with the top surface of the base member in a flat state. Further, when a worker applies an excessive amount of force to the die, the die may break be damaged. Also, the process of separating the die is inconvenient, and working efficiency is inevitably reduced.

Further, dental laboratory work is performed on the die which is cut off from the dental model of the patient whose teeth are to be treated and which is separated from the base member. In detail, to check an occlusal relationship between the maxillary articulator and the mandibular articulator, a space between adjacent teeth, and so forth, a process of putting the separated die into and out of the base member is repeated as needed.

In this manner, while the process of fitting the cut dental model, i.e. the die, into and out of the pin fixing holes of the base member is repeated, the die undergoes left-and-right movement even in a state where the die is clamped to the base member, because a predetermined gap is generated from opposite ends of the die by the sawing. This left-and-right movement makes it difficult not only to perform the dental laboratory work, but also to complete a precise dental prosthesis for a patient.

In particular, since a shape of the lower end of the body of each pin coupled to the die is a cylindrical shape, the gap or the movement of the die is further developed due to a slip between the dental model fixing pin and the pin fixing hole even when the dental model fixing pins are accurately fitted into the pin fixing holes.

Further, when the separated die is fitted back into the base member at its original location, it is difficult to find the original spot, and after it is found, to correctly fit the lower end of each dental model fixing pin protruding from the bottom surface of the die.

Further, when the die is separated from the dental model coupled to the base member, the pointed tool is inserted between the die and the base member, and then the die is separated from the base member. In this case, to make separating the die more convenient, among the dental model fixing pins that are inserted into and fixed in the base member, the dental model fixing pin coupled to the corresponding dental model is located on the bottom surface of the base member, and the lower end thereof is pressed by a tool or a finger, thereby separating the die from the base member. Since each pin fixing hole of the base member used in a conventional articulator are designed to enclose the entire lower end of each dental model fixing pin, it is very inconvenient to push the lower ends of the dental model fixing pins to separate the die.

Examples of this conventional articulator include U.S. Pat. Nos. 6,511,318; 6,485,302; 6,318,999; and so on. FIGS. 1 and 2 show examples of this conventional articulator.

As shown in the figures, a conventional articulator 5 or 5a is configured so that a toothed member 3 or 3a having a predetermined height is formed on the top surface of a base member 4 or 4a, thereby effectively preventing movement of the plaster dental model coupled to the base member.

However, this base member 4 or 4a has a complicated structure, and dental model fixing pins coupled to the base member 4 or 4a are fitted into pin fixing holes. In this case, a lower end of each dental model fixing pin is located inside the corresponding pin fixing hole, so that it is very inconvenient to press the lower end of each dental model fixing pin fitted into the corresponding pin fixing hole from a bottom surface of the base member and to separate a die.

Further, this conventional articulator 5 or 5a is configured so that a support member is installed on a rear end of the base member for maxillomandibular occlusion, and thus maxillary and mandibular articulators are integrally coupled to each other.

Thus, opposite ends of the support member 2 or 2a protruding outwardly from the base member 4 or 4a by a predetermined length are hinged, and a connector C for adjusting a maxillomandibular occlusion angle between the maxillary and mandibular articulators is formed at one end, i.e. a leading end of the support member 2 or 2a, so that the occlusion angle is easily adjusted. However, the strength of the support member is weak, and a inconvenient process of applying an instant adhesive or the like to the connector in order to match maxillary and mandibular positions, and fixing the support member and the base member, is additionally required.

Further, there is an example in which, to enhance the strength of this support member, the support member is fixed on a rear end face of the base member in a vertical direction, and is hinged to the support member of the maxillary articulator at an upper end thereof. As the angle between the base member and the support member approaches a right angle, the strength of the support member supporting the base member is increased; however, there is a drawback in that it becomes more and more inconvenient to perform the process of plastering the dental model onto the top surface of the base member.

In contrast, as the angle between the base member and the support member increases, it is convenient to perform the process of plastering the dental model on the top surface of the base member; however, the support member is apt to bend or be deformed due to weight of the plaster placed on the top surface of the base member, and thus it is difficult to accurately realize the temporomandibular joint of a patient. To avoid this difficulty, the strength of the support member should be increased. When the strength is increased, the weight and volume are increased.

### SUMMARY OF THE INVENTION

Accordingly, the present invention has been made keeping in mind the above problems occurring in the related art, and an objective of the present invention is to provide a dental articulator that provides a simple structure for a base member and includes a protrusion bed and fixing holes, both of which are capable of effectively preventing arbitrary movement of a die when the die separated from the base member is re-coupled.

Another objective of the present invention is to provide a dental articulator of a hardened plaster dental model wherein the corners of the protrusion bed formed on the top face of the base member when the die is separated from the base member are prevented from breaking, and a dental model fixing pin can be easily pressed on a bottom face of the base member when the die is separated so as to allow the die to be separated conveniently.

Another objective of the present invention is to provide a dental articulator that provides the appropriate arrangement of support members coupled to the base member to facilitate plastering and subsequent processes, and facilitates occlusion and mastication between maxillary and mandibular articulators.

Another objective of the present invention is to provide a dental model fixing pin used for a dental articulator, which is fitted into a pin fixing hole formed in the base member of the dental articulator and includes a body having round portions and vertical cut portions, so that arbitrary movement in the pin fixing hole of the dental model fixing pin itself can be prevented, and the dental model fixing pin can be easily released from the pin fixing hole.

In order to achieve the above objective, according to one aspect of the present invention, there is provided a dental articulator having a base member for molding a dental model for a patient. The base member includes a protrusion bed that is formed on a top face of the base member along a central line in a lengthwise direction of the base member, comes into contact with a plaster dental model placed on the top face of the base member, and has a predetermined height, length, and width. The protrusion bed includes a plurality of pin fixing holes in a middle portion thereof, the plurality of pin fixing holes being spaced apart from one another at regular intervals and passing through an interior of the base member.

Particularly, the protrusion bed is rounded at front and rear edges and side edges thereof so that oblong segments are continuously interconnected to form corrugated parts, each of which has pits and projections, along the side edges thereof.

Further, the corrugated parts formed along the side edges of the protrusion bed are configured so that a cross-sectional width of each pit is different from that of each projection. Each pin fixing hole passing through the base member is formed in a tapered shape in which an inner width thereof is gradually reduced from an upper end thereof to a lower end thereof.

According to one aspect of the present invention, there is provided a dental model fixing pin, which includes a head that includes a knurled anti-skid portion on an outer circumference of an upper end of the dental model fixing pin, and a body that extends from a lower end of the head so as to have a cross section and a length greater than those of the head. The body has a tapered shape in which a cross-sectional width thereof is gradually reduced from an upper portion thereof to a lower portion thereof.

Particularly, the body of the dental model fixing pin includes vertical cut portions that are cut to a predetermined depth on opposite sides thereof and has the same vertical face in a downward direction. The base member includes a pin fixing hole structure in a bottom face thereof so that the pin fixing holes pass therethrough. The pin fixing hole structure is formed to have a lower height than sidewalls of the base member.

Further, a flat joint plate of a predetermined size is formed on a rear face of the base member. The joint plate includes a pair of support members which are formed on a top face thereof. The pair of support members are spaced apart from each other by a predetermined distance, are inclined outwards in an upward direction, and are configured so that an interval therebetween is gradually increased from lower portions thereof, which are connected with the joint, to upper portions thereof.

Particularly, the support members include male and female connectors at left and right upper ends thereof in a snap structure so as to be spaced apart from each other, respectively. One of the connectors includes a pin-shaped pivot piece, whereas the other connector includes a recessed clamp piece into which the pivot piece is inserted.

Further, one of the pivot piece and the clamp piece includes a cylindrical stopper in a front thereof which has a predetermined height in an upward direction so as to prevent maxillary and mandibular articulators from being folded beyond a predetermined angle when the maxillary and mandibular articulators are coupled and occluded to each other.

As described above, the dental articulator according to the present invention can simplify the structure of the base member and effectively prevent the arbitrary movement of the separated die, thus making it possible to fabricate a dental prosthesis for a patient with higher precision and to further facilitate realization of the dental model.

Further, the pin fixing holes formed in the base member and the dental model fixing pins fitted into the pin fixing holes are tapered from the top to the bottom, so that they can be easily separated or coupled.

Further, the vertical cut portions are formed on opposite sides of the body of the dental model fixing pin, so that the dental model fixing pin is effectively prevented from arbitrary moving in the pin fixing hole after the dental model fixing pin is fitted into the pin fixing hole, and thus it is easy to fabricate a dental prosthesis for a patient.

In the dental articulator according to the present invention, when the die is separated from the base member, the edges of the protrusion bed are rounded, so that it is possible to prevent the plaster of the separated die from being broken at its corners.

Further, when the die is separated, the lower end of the dental model fixing pin which is partially protrudes from the bottom face of the base member is pushed by a finger, so that it is easy to separate the die.

Further, the primary stopper is formed on the upper end of the support member, and the auxiliary stopper is formed on the top surface of the joint plate. These stoppers prevent the maxillary and mandibular articulators from being excessively occluded beyond a predetermined angle when the maxillary and mandibular articulators are occluded.

In addition, when the maxillary and mandibular articulators are folded beyond a proper occlusion angle depending on the condition of a patient, the stoppers can be simply eliminated, so that the occlusal relationship of the dental model of the patient can be checked at various occlusion angles depending on the conditions of the patient and results of molding the dental model.

Further, the upper ends of the primary and auxiliary stopper are rounded. Thus, when a torsion angle should be imparted to the connector depending on the arrangement of teeth of the patient after the maxillary and mandibular articulators are folded at an occlusion angle, the rounded upper ends of the stoppers slide on the corresponding flat surfaces to permit eccentric occlusion.

A hinge part of the connector formed at a leading end of the support member protrudes outwardly beyond the support member, thereby facilitating extraction from a metal mold when a product is produced by the metal mold. In the hinge part having a male or female structure, a clamp piece having the female structure is provided with a slit in an inner circumference thereof. Thus, when the pivot piece of a counter dental articulator is connected to the clamp piece, the clamp piece elastically moves to provide convenient assembling work.

### BRIEF DESCRIPTION OF THE DRAWINGS

The above and other objectives, features and other advantages of the present invention will be more clearly understood from the following detailed description when taken in conjunction with the accompanying drawings, in which:

FIGS. 1 and 2 show examples of a conventional articulator;

FIG. 3 is an external perspective view showing a dental articulator according to an embodiment of the present invention;

FIG. 4 is a side view of FIG. 3;

FIG. 5 is a bottom-up view of FIG. 3;

FIG. 6 is a cross-sectional view taken along line A-A of FIG. 3;

FIGS. 7 and 8 are an external perspective view and a side view showing a dental model fixing pin applied to the dental articulator according to the embodiment of the present invention; and

FIGS. 9 and 10 are a perspective view showing a die separated from a base member in a state in which a plaster dental model is placed in the articulator according to the embodiment of the present invention, and a longitudinal sectional view showing the plaster dental model coupled to the base member.

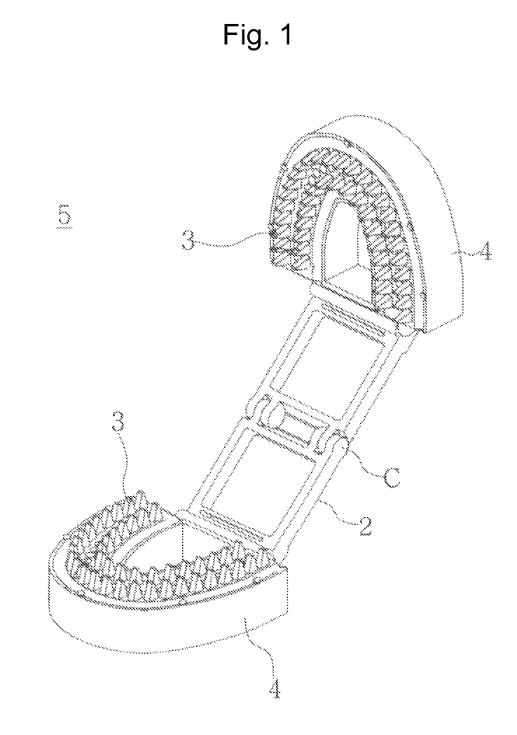

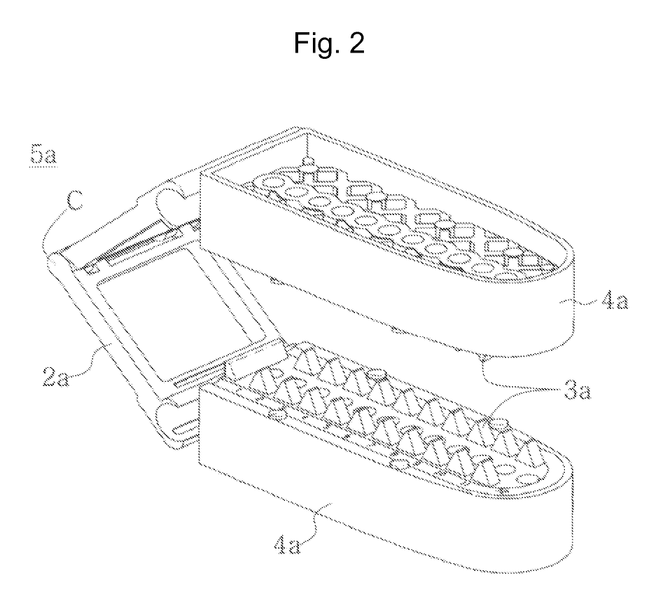

### DETAILED DESCRIPTION OF THE INVENTION

A dental articulator according to an exemplary embodiment of the present invention includes a base member for molding a dental model for a patient, and support members formed on a rear end of the base member and configured to be able to couple maxillary and mandibular articulators.

Particularly, the base member includes a protrusion bed that is formed on a top face of the base member along a central line in a lengthwise direction of the base member, comes into contact with a plaster dental model placed on the top face of the base member, and has a predetermined height, length, and width. The protrusion bed includes a plurality of pin fixing holes in a middle portion thereof, wherein the plurality of pin fixing holes are spaced apart from one another at regular intervals, and pass through an interior of the base member.

The protrusion bed has a flat top face, and is rounded at front and rear edges and side edges thereof so that oblong segments are continuously interconnected to form corrugated parts, each of which has pits and projections, along the side edges thereof.

Further, the corrugated parts formed along the side edges of the protrusion bed are configured so that a cross-sectional width (or a length) of each pit is different from that of each projection. Each pin fixing hole passing through the base member is formed in a tapered shape in which an inner width thereof is gradually reduced from an upper end thereof to a lower end thereof.

Further, a dental model fixing pin fitted into the pin fixing hole formed in the base member includes a head that includes a knurled anti-skid portion on an outer circumference of an upper end of the dental model fixing pin which is fitted into the bottom face of the plaster dental model placed on the top face of the base member, and a body that extends from a lower end of the head so as to have a cross section and a length greater than those of the head.

Particularly, the body has a tapered shape in which a cross-sectional width thereof is gradually reduced from an upper portion thereof to a lower portion thereof, so that the body can be fitted into and separated from the pin fixing hole of the base member.

Further, the pin fixing hole of the base member and the body of the dental model fixing pin includes vertical cut portions that are cut to a predetermined depth on opposite sides thereof and has the same vertical face in a downward direction, and curved round portions on the other opposite sides thereof, i.e. on the sides where the vertical cut portions are not formed.

A bottom face of the base member of the dental articulator is provided with a pin fixing hole structure that has the pin fixing holes passing through the base member. The pin fixing hole structure is formed to have a lower height than sidewalls of the base member.

Thus, the body of the dental model fixing pin is configured so that a lower end of the dental model fixing pin is configured to be partially exposed to a lower end of the pin fixing hole structure, and so that, although the dental model fixing pin is partially exposed to the outside of the lower end of the pin fixing hole structure, there is a predetermined height difference between the exposed lower end of the dental model fixing in and the lower end of the base member.

Due to the height of the pin fixing hole structure configured in this way, when the base member is placed on a flat table, there is no difficulty in maintaining the dental model fixing pin in a horizontal state even when the dental model fixing pin protrudes downwards. When the die is separated from the base member, the exposed portion of the dental model fixing pin is pushed on the bottom face of the base member, so that it is easy to separate the die.

Reference will now be made in greater detail to a dental articulator and its pin set according to an exemplary embodiment of the invention with reference to the accompanying drawings.

In the accompanying drawing of the present invention, a quadrant type dental articulator was selected from among various types of dental articulators to describe features of the present invention by way of example. It is noted that characteristic configuration of the present invention can be applied regardless of the type of dental articulator.

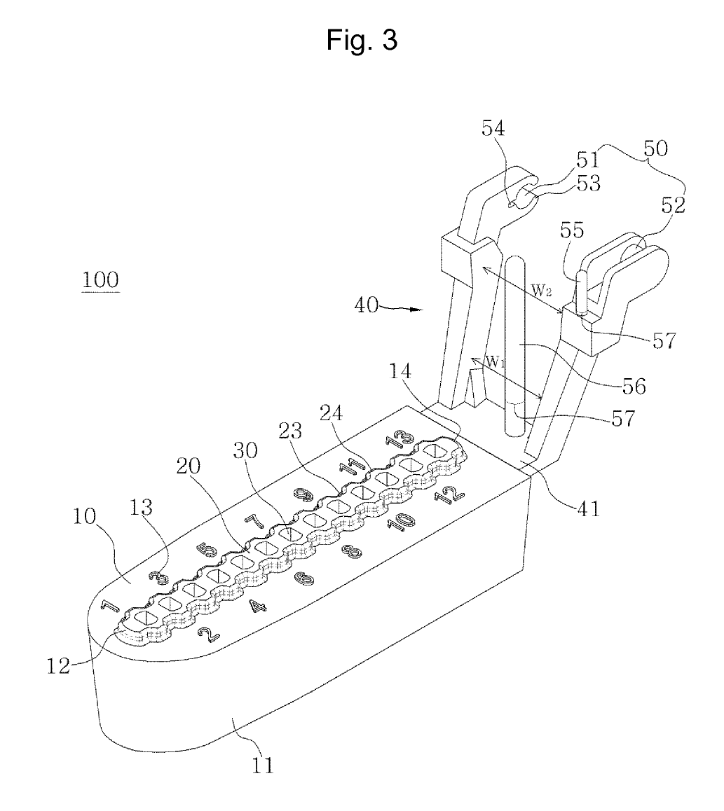

FIG. 3 shows a mandibular articulator 100 in a dental articulator according to an embodiment of the present invention. Since a maxillary articulator has the same configuration, the features of the present invention are described below on the basis of the mandibular articulator.

As shown, the articulator 100 according to an embodiment of the present invention is characterized by a base member 10 that serves as a basic framework for molding a dental model for a patient using a dental plaster.

In detail, the base member 10 is formed of a plastic synthetic resin that is lightweight for convenient use and is excellent in strength, has a predetermined height, a rounded front face, and sidewalls 11 inclined inwardly from the top to the bottom thereof.

Further, the base member 10 is provided with a protrusion bed 20 in the middle of a top surface thereof. The protrusion bed 20 has a predetermined height, length, and width so as to come into contact with a plaster dental model placed on the top face of the base member 10, and is formed in the same direction as the lengthwise direction of the base member 10. The protrusion bed 20 is formed so that a top face thereof is flat, that a height thereof ranges from about 1 mm to about 3 mm, and that front and rear edges 12 and 14 and side edges thereof, are smoothly rounded on the whole.

The protrusion bed 20 is provided with a plurality of pin fixing holes 30 in a middle portion thereof. The plurality of pin fixing holes 30 are spaced apart from one another at regular intervals in a lengthwise direction of the protrusion bed 20, and pass through the interior of the base member 10 in a vertical direction.

Further, pin hole numbers 13 representing numbers of the pin fixing holes 30 are alternately formed on both sides of the protrusion bed 20. The pin hole numbers 13 are formed in relief. Thus, after the plaster dental model that is placed on the top face of the base member is hardened, the pin hole numbers 13 are marked in intaglio in a bottom face of the hardened plaster dental model for the purpose of easy identification.

The outer edges of the protrusion bed 20 formed on the top face of the base member 10 are rounded as described above. As a result, when the plaster dental model placed and molded on the top face of the base member 10 is hardened and separated from the base member 10, the hardened plaster dental model can be prevented from being broken at corners of the protrusion bed.

The protrusion bed 20 has a shape in which oblong segments are continuously connected with one another, and thus pits 23 and projections 24 are alternately formed to become corrugated parts on the side edges of the protrusion bed 20. As such, the protrusion bed 20 can be firmly coupled with the bottom face of the plaster dental model. Further, the intagliated recess corresponding to the protrusion bed is formed in the bottom face of a part (or a die) separated from the entire dental model, so that the separated die can be put back in its place or be effectively prevented from being arbitrarily displaced.

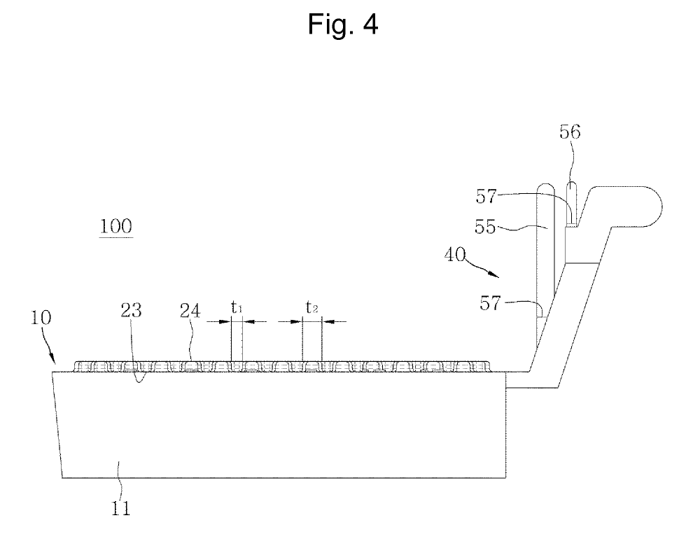

FIG. 4 is a side view showing the aforementioned articulator 100. As shown in FIG. 4, the pits 23 and the projections 24, both of which are formed along the side edges of the protrusion bed 20, are designed so that a cross-sectional length t1 of each pit 23 is different from that t2 of each projection 24.

For example, in the corrugated parts of the protrusion bed 20, the cross-sectional length t2 of each projection 24 may be smaller (or greater) than the cross-sectional length t1 of each pit 23. Thus, when the die separated from the entire dental model molded on the top face of the base member is re-coupled to the base member, the die can be conveniently put back in its place. Further, the die separated from the entire dental model can be effectively prevented from being displaced left and right after the die is coupled to the base member.

In the protrusion bed 20 shown in the figure, the left and right corrugated parts are formed so as to be symmetrical with respect to each other (the state in which the left-hand pits are opposite to the right-hand pits). However, the left and right corrugated parts may be formed so as to be asymmetrical with respect to each other (the state in which the left-hand pits are opposite to the right-hand projections). In this case, when the die is re-coupled after being separated, the separated die can be prevented from being properly fitted into the corrugated parts if the dental model is located in the wrong direction.

Further, the base member 10 is configured so that each sidewall 11 thereof has an inclined face increasingly inclined inwardly from the top to the bottom thereof When the dental model is placed and molded on the top face of the base member 10, the plaster flows down the sidewalls of the base member 10 while being hardened. Thus, when grinding work is carried out to remove the plaster, a grinder easily comes into contact with the inclined face, so that the base member has clean outer faces due to the easy grinding work.

The base member 10 is provided with support members 40 on a rear end thereof for the purpose of occlusion between maxillary and mandibular articulators. Configuration and operation of the support members 40 will be separately described below.

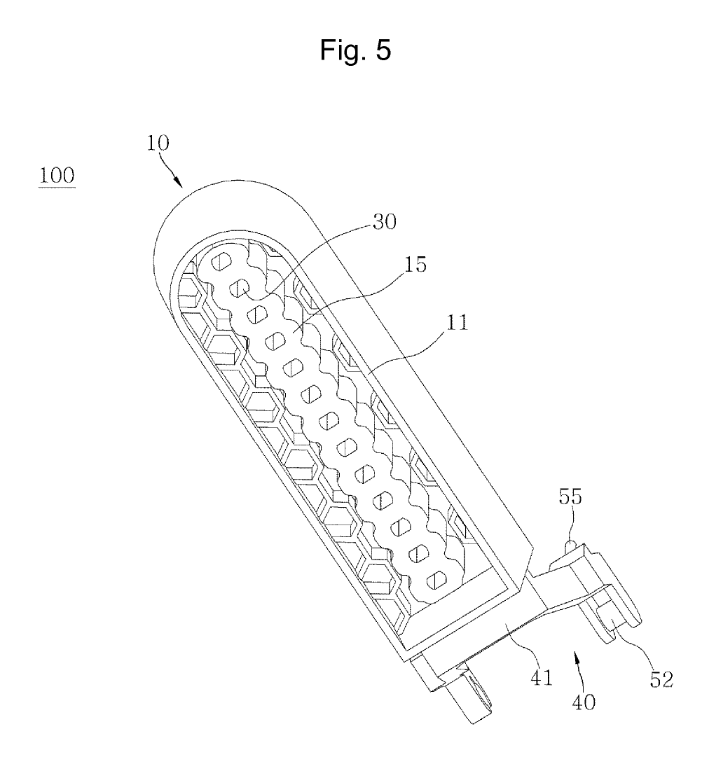

Meanwhile, FIG. 5 is a bottom perspective view showing the base member 10. The base member 10 is provided with a pin fixing hole structure 15 inside the bottom face thereof. The pin fixing hole structure 15 is formed inside the sidewalls 11 of the base member 10 to a predetermined height in order to form the pin fixing holes 30 from the top to the bottom.

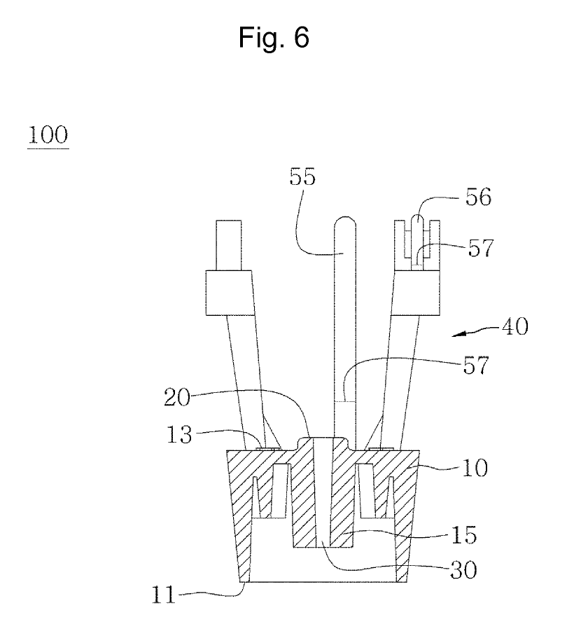

In detail, as shown in a cross-sectional view of FIG. 6, the pin fixing hole structure 15 is formed so as to be somewhat lower than heights of the sidewalls 11 of the base member 10, so that a height difference is formed to a certain extent between a lower end of the pin fixing hole structure 15 and lower ends of the sidewalls 11.

Thus, when each dental model fixing pin is inserted into the pin fixing hole structure 15, the pin fixing hole structure 15 is formed to such a height that it can support a body of each dental model fixing pin and that a lower end of each dental model fixing pin can be partially exposed to the lower end of the pin fixing hole structure 15.

The pin fixing hole structure 15 is configured so that its height is set to a height to which the lower end of the dental model fixing pin coupled into the pin fixing hole can be partially exposed to the lower end of the pin fixing hole structure 15, i.e. a height that is somewhat smaller than a length of the body of the dental model fixing pin, and is somewhat lower than the heights of the sidewalls 11 of the base member 10.

Thus, although the dental model fixing pin is coupled into the pin fixing hole, the base member 10 is placed on a flat table so that there is a predetermined height difference maintained between the lower end of the dental model fixing pin and the lower ends of the sidewalls 11, so that the base member can be stably maintained in a horizontal state by preventing the exposed lower end of the dental model fixing pin from coming into contact with the flat table.

In particular, each pin fixing hole 30 passing through the pin fixing hole structure 15 is configured to maintain a tapered shape in which an inner width thereof is gradually reduced from the top end to the lower end thereof, so that each dental model fixing pin is allowed to freely come in and out of the corresponding pin fixing hole.

Further, each pin fixing hole 30 maintains the tapered shape in which the inner width thereof is gradually reduced from the top to the bottom, and has a structure in which linear vertical cut portions 32 are formed in opposite forward and backward directions and in which curved round portions 34 are formed in left and right directions. Thus, the dental model fixing pin fitted into the pin fixing hole can be effectively inhibited from arbitrary movement.

The support members 40 are installed on the rear face of the base member 10 for the purpose of occlusion between maxillary and mandibular articulators. The support members 40 are formed on a joint plate 41, which is coupled to the rear face of the base member 10 that has a predetermined size, and are placed in a pair spaced apart from each other by a predetermined distance.

That is, the support members 40 are designed so that an interval W₂ between upper portions thereof is wider than that W₁ between lower portions thereof, and so that the upper portions thereof are spaced apart from the base member 10 so as to be farther than the lower portions thereof in an inclined structure. Thereby, it is possible to efficiently support weight of the plaster dental model coupled to the top face of the base member 10 (see FIG. 3).

Particularly, the support members 40 are configured to be coupled to the base member 10 by the separate joint plate 41 so as to be spaced apart from the base member 10 by a predetermined distance, rather than be directly coupled to the rear end of the base member 10. Thereby, the process of molding the plaster dental model on the top face of the base member 10 or the subsequent process of grinding the plaster dental model after the plaster dental model is hardened can be conveniently performed.

Meanwhile, the support members 40 are provided with male and female connectors 50 at upper ends thereof so as to protrude outwardly from bodies thereof, respectively. Each of the male and female connectors 50 has a snap structure so as to allow the maxillary and mandibular articulators to be easily coupled to or decoupled from each other (see FIG. 3).

In detail, the male and female connectors 50 having the snap structure include a pin-shaped pivot piece 52 and a recessed clamp piece 51 into which the pivot piece 52 is inserted and pivotably clamped, respectively, so as to enable a worker to easily handle a counter articulator when the counter articulator is connected to and disconnected from the articulator. The clamp piece 51 is provided with an opening 53 in the front thereof into which the pivot piece 52 can be fitted (see FIG. 3).

The clamp piece 51 is additionally provided with a slit 54 in an inner circumference thereof so that, when the pivot piece 52 of the support member of the articulator is connected to the counter clamp piece 51 of the support member of the counter articulator, the pivot piece 52 can be elastically clamped to the counter clamp piece 51. The connector 50 formed at the upper end of one of the support members 40 is provided with a cylindrical primary stopper 55 in the front thereof which has a predetermined height in an upward direction.

When the maxillary and mandibular articulators are coupled and pivot about the connectors 50, the primary stopper 55 is allowed to prevent the maxillary and mandibular articulators, to each of which the dental model is coupled, from being folded beyond a predetermined angle.

That is, when the maxillary and mandibular articulators pivot about the connectors 50 in order to check occlusal and masticatory relationships between the two articulators, the top face of the primary stopper 55 formed on one of the support members 40 of the articulator comes into contact with a front portion of the connector of the counter articulator, so that it is possible to prevent the articulators from being excessively folded.

Further, the joint plate 41 is additionally provided with an auxiliary stopper 56 on a top face thereof, and particularly at a position that deviates from the middle between the pair of support members 40. The auxiliary stopper 56 prevents excessive occlusion between the maxillary and mandibular articulators. Particularly, in the case of a free end type dental model from which the molars of the teeth of a patient are excluded, the auxiliary stopper 56 is able to prevent the excessive folding.

The top faces of the primary and auxiliary stoppers 55 and 56 are formed in a round shape. The primary and auxiliary stoppers 55 and 56 come into contact with the front portion of one connector of the counter articulator and the top face of the joint plate 41 of the counter articulator, respectively. In this case, when a torsion angle should be given to the support members 40 according to the arrangement of the teeth of a patient, the round top faces of the primary and auxiliary stoppers 55 and 56 are adapted to smoothly slip, so that the counter articulator can be flexibly twisted.

Further, each of the primary and auxiliary stoppers 55 and 56 is provided with a removal notch 57 having a predetermined depth in a lower end thereof in a circumferential direction.

The removal notches 57 are intended to allow the primary and auxiliary stoppers 45 and 46 to be removed when the maxillary and mandibular articulators should be folded beyond a typical occlusal angle due to the dental structure of a patient.

In detail, when the maxillary and mandibular articulators are occluded, they no longer fold due to the primary and auxiliary stoppers 55 and 56. In this case, when a worker pushes aside the upper ends of the primary and auxiliary stoppers 55 and 56, the primary and auxiliary stoppers 55 and 56 are easily broken and removed at positions where the removal notches 47 are formed, so that the maxillary and mandibular articulators can be folded beyond a predetermined angle so as to enable the worker to check the occlusal and masticatory relationships between the maxillary and mandibular articulators.

Although the primary stopper 55 is formed only on any one of the opposite support members 40, the maxillary and mandibular articulators can be used in the same structure. For example, when the primary stopper is located at the left support member of the maxillary articulator, the primary stopper is located at the right support member of the mandibular articulator. That is, the maxillary and mandibular articulators have a symmetrical structure. As a result, when the maxillary and mandibular articulators are coupled to each other, the primary stoppers are located at the opposite support members.

Further, the auxiliary stopper 56 is also formed so as to deviate from the middle between the opposite support members in one direction. Thereby, when the maxillary and mandibular articulators are occluded, the auxiliary stopper formed on the maxillary articulator and the auxiliary stopper formed on the mandibular articulator are located at diagonal positions, and are configured to come into contact with the joint plates of the respective articulators in a symmetrical structure.

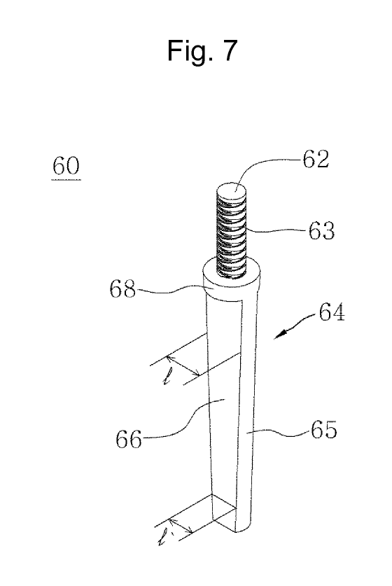

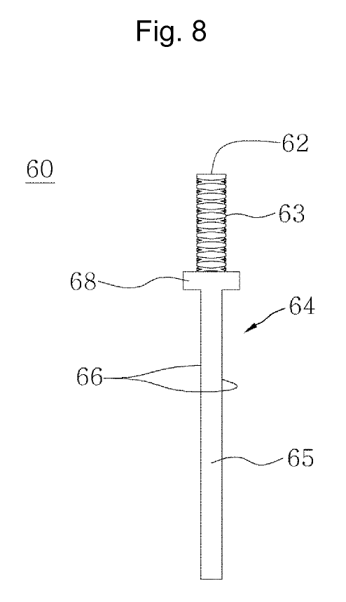

Meanwhile, FIGS. 7 and 8 are an external perspective view and a side view showing the dental model fixing pin 60 which is fitted into the pin fixing hole 30 of the dental articulator 100 and supports the dental model.

As shown in FIGS. 7 and 8, the dental model fixing pin 60 according to the present invention has a structure in which a head 62 having a predetermined length is formed on an upper end thereof and a body 64 is formed under the head 62 so as to be longer (about 2.5 to 3 times) than the head 62.

The head 62 is provided with a knurled anti-skid portion 63 on an outer circumference thereof so as to be firmly coupled with the plaster dental model, and the body 64 extends from a lower end of the head 62 so that the cross section and length of the body 64 are greater than those of the head 62.

That is, the head 62 and the body 64 of the dental model fixing pin 60 are cylindrical on the whole. The body 64 has the same tapered shape as the inner shape of the pin fixing hole 30, in which a cross-sectional width thereof is gradually reduced from an upper portion thereof to a lower portion thereof (1>1′).

Further, the body 64 has a structure in which cylindrical round portions 65 on opposite sides thereof keep their original shapes, and vertical cut portions 66 are formed on opposite sides thereof in a direction perpendicular to the round portions 65 by vertically cutting the body 64 to a predetermined depth.

Further, as shown in the side view of FIG. 8, a step portion 68 is formed on an upper end of the body by a difference in diameter between the head 62 and the body 64. When the body 62 is inserted into the pin fixing hole 30, the step portion 68 is located at an upper portion of the pin fixing hole 30, so that it serves to prevent the plaster for the dental model placed on the top face of the base member from being introduced into the pin fixing hole 30 and as a catch step so that the body is no longer inserted into the pin fixing hole 30.

The dental model fixing pin 60 having this shape is fitted into the pin fixing hole 30 in such a manner that the vertical cut portions 66 formed on the opposite sides of the body 64 are matched with the vertical cut portions 32 formed in the forward and backward directions of the pin fixing hole 30 and so that the round portions 65 of the body 64 are matched with the round portions 34 formed in the left and right directions of the pin fixing hole 30.

Thus, a position at which the dental model fixing pin 60 is inserted is determined by the vertical cut portions 32 and 66 and by the round portions 34 and 65 formed on the pin fixing hole 30 and the body 64 of the dental model fixing pin 60, so that inserting the pin is convenient, and it is possible to prevent only the dental model fixing pin itself from arbitrarily moving in the pin fixing hole.

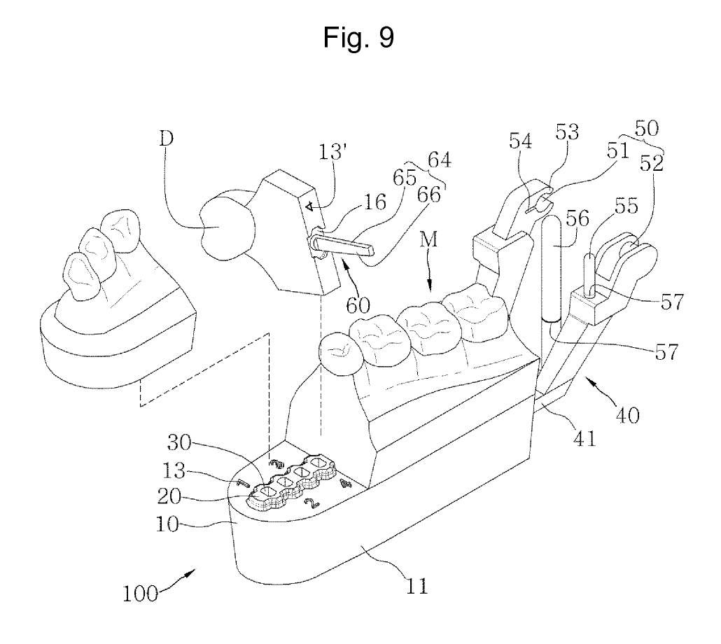

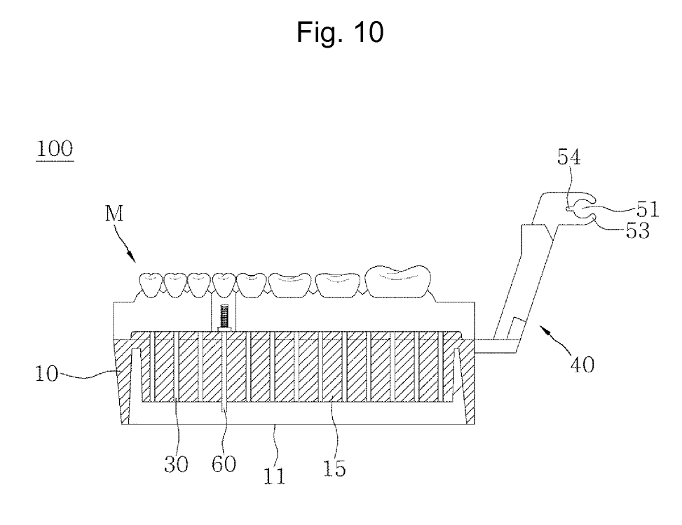

Meanwhile, the process of molding and machining the dental model using the articulator 100 and its dental model fixing pin 60 having the above configuration and structure will be described below with reference to FIGS. 9 and 10.

The process of molding the dental model will now be briefly described. As described above, after the dental model fixing pins are inserted into the plurality of pin holes formed in the top face of the base member at regular intervals, a dental model molded of dental plaster using the dental impression of a patient is placed on the top surface of the base member into which the pins are inserted, and then is hardened, so that the dental model M for the patient is obtained.

Since the vertical cut portions and the round portions are formed on the dental model fixing pins 60 and in the pin fixing holes 30 in accordance with the present invention, the positions where the dental model fixing pins are fitted into the base member are set. As such, a process of fitting the pins becomes convenient.

Of course, to mold the dental model, a mold is prepared using a tray having the same shape as the base member, and then is placed on the base member.

After the dental model of a patient is hardened on the base member, the tray fixing the base member 10 is removed, and then the base member 10 is ground to remove the plaster flowing down an outer circumferential surface of the base member 10.

After the grinding process is performed, the integrally molded dental model is sawed to separate a partial dental model corresponding to the teeth which are to be treated.

The series of processes by which the die D, which is the partial dental model of a patient required for treatment, is separated from the base member 10 is shown in FIG. 9.

The die D, which is separated from the top face of the base member 10, has the dental model fixing pins 60 integrally coupled to a bottom face thereof The bottom face of the separated die D has a pin hole number 13′ formed in intaglio by a pin hole number 13 formed in relief on the top face of the base member 10. Thus, after a worker performs desired processes, the die D is again fitted into the base member 10. In this case, the worker looks at the pin hole number 13′ represented in the bottom face of the die D, and then fits the die D at a corresponding position. Thus, finding the original location of the die D is more convenient.

Further, the protrusion bed 20 formed on the top face of the base member 10 is copied into a recess 16 in the bottom face of the die D. Thus, when the separated die is again coupled to the base member, the die D is effectively prevented from arbitrarily moving on the top face of the base member 10 by the coupling of the recess 16 and the protrusion bed 20. Further, the die D is not accurately fitted at another location by the pits and projections of the connected oblong segments, so that the trouble of finding the original location of the separated die does not take place.

Particularly, the protrusion bed 20 and the recess 16 serve as auxiliary pins that additionally support the die D fixed to the base member 10 by the dental model fixing pin, and thus provides a structure in which, although the die D is separated from the entire dental model, the die D is not easily displaced after being fixed to the base member 10.

Further, both the dental model fixing pin 60 coupled to the bottom face of the die D and to the pin fixing hole 30 are formed in a tapered shape in which the top is wide and the bottom is narrow. When the dental model fixing pin 60 is fitted into or released from the pin fixing hole 30, the sensation when it is coupled and decoupled is good.

In addition, after the dental model fixing pin 60 is fitted, the vertical cut portions 32 and the round portions 34 formed in the pin fixing hole 30 come into close contact with the vertical cut portions 66 and the round portions 65 formed on the body 64 of the dental model fixing pin 60. Thus, the displacement of the die is effectively prevented, and is not easily separated from the base member when used for the maxillary articulator because a predetermined contact interface is maintained between the pin fixing hole and the body of the dental model fixing pin.

Further, the pits 23 and the projections 24, both of which are formed along the side edges of the protrusion bed 20, are designed so that a length of each pit is different from that of each projection. Thus, when the die, which was separated from the base member 10, is re-coupled to the base member, accurately finding the original location of the die D is more convenient because the die is not coupled at another place when the lengths of the pit 23 and the projection 24 are different from each other. Further, the die D is effectively prevented from being displaced left and right.

Further, as shown in the side view of FIG. 10, the dental model fixing pin 60 coupled to the dental model M is configured so that the lower end of the body 64 thereof passes through the pin fixing hole 30 of the base member 10 and is partially exposed to the lower end of the pin fixing hole structure 15. As such, when the die D is separated from the base member 10, a worker presses the exposed lower end of the dental model fixing pin 60 which is exposed to the bottom face of the base member 10 using a tool or his/her finger, so that the die D is easily separated from the base member. Thus, it is possible to improve working convenience.

Further, in the case of the dental model fixing pin 60, its body 64 is configured so that the round portions 65 thereof are tapered on both sides to function to facilitate separation of the die from the base member, and so that the vertical cut portions 66 formed on the other sides come into surface contact with the inner face of the pin fixing hole 30, and are allowed to prevent the die D from being separated from the pin fixing hole 30 without resistance due to dead weight of the die D during the masticatory operation although the die belongs to the maxillary articulator for a patient.

Further, the corners of the front and rear edges 12 and 14 and the pits 23 and the projections 24 of the protrusion bed 20 are smoothly rounded. When the dental model is separated from the base member 10, it is easy to separate the dental model. Further, when the dental model is separated, it is possible to prevent the plaster from being broken or cracked at the corners of the protrusion bed.

Although an exemplary embodiment of the invention has been described for illustrative purposes, those skilled in the art will appreciate that various modifications, additions and substitutions are possible, without departing from the scope and spirit of the invention as disclosed in the accompanying claims.

According to the inventive dental articulator configured as described above, the dental articulator is able to conveniently fabricate the dental model of a patient so that it can be used to fabricate the dental model of the patient at dental clinics and laboratories.

Particularly, the plastic dental articulator fabricated as a disposable dental articulator is simplified in structure to facilitate a design and metal mold fabrication, and the projection bed formed on the top face of the base member prevents the die from being arbitrarily displaced, and allows easy separation and coupling of the die.

Further, according to the dental model fixing pins for the dental articulator, the pin fixing holes formed in the base member and the dental model fixing pins fitted into the pin fixing holes are each tapered to facilitate fitting and separation. The body of each dental model fixing pin has both the vertical cut portions and the round portions, so that it is possible to prevent arbitrary movement of the die and to firmly couple the die.

What is claimed is:

1. A dental articulator having a base member for molding a dental model for a patient, in which:
the base member includes a protrusion bed that is formed on a top face of the base member along a central line in a lengthwise direction of the base member, comes into contact with a plaster dental model placed on the top face of the base member, and has a predetermined height, length, and width; and
the protrusion bed includes a plurality of pin fixing holes in a middle portion thereof, the plurality of pin fixing holes being spaced apart from one another at regular intervals and passing through an interior of the base member.

2. The dental articulator according to claim 1, wherein the protrusion bed has a flat top face, and is rounded at front and rear edges and side edges thereof so that oblong segments are continuously interconnected to form corrugated parts, each of which has pits and projections, along the side edges thereof.

3. The dental articulator according to claim 2, wherein the corrugated parts formed along the side edges of the protrusion bed are configured so that a length of each pit is different from that of each projection.

4. The dental articulator according to claim 3, wherein each pin fixing hole passing through the base member is formed in a tapered shape in which an inner width thereof is gradually reduced from an upper end thereof to a lower end thereof.

5. The dental articulator according to claim 4, wherein each pin fixing hole is configured so that an inner circumference thereof has curved round portions in left and right directions and linear vertical cut portions in forward and backward directions.

6. The dental articulator according to claim 5, wherein the base member includes a pin fixing hole structure in a bottom face thereof so that the pin fixing holes pass therethrough, the pin fixing hole structure being formed to have a lower height than sidewalls of the base member.

7. The dental articulator according to claim 4, wherein the base member includes a pin to fixing hole structure in a bottom face thereof so that the pin fixing holes pass therethrough, the pin fixing hole structure being formed to have a lower height than sidewalls of the base member.

8. The dental articulator according to claim 7, wherein a flat joint plate of a predetermined size is formed on a rear face of the base member, the joint plate including a pair of support members which are formed on a top face thereof the pair of support members being spaced apart from each other by a predetermined distance, being inclined outwards in an upward direction and being configured so that an interval therebetween is gradually increased from lower portions thereof, which are connected with the joint, to upper portions thereof.

9. The dental articulator according to claim 6, wherein a flat joint plate of a predetermined size is formed on a rear face of the base member, the joint plate including a pair of support members on a top face thereof, the pair of support members being spaced apart from each other by a predetermined distance, being inclined outwards in an upward direction, and being configured so that an interval therebetween is gradually increased from lower portions thereof, which are connected with the joint, to upper portions thereof.

10. The dental articulator according to claim 1, wherein a flat joint plate of a predetermined size is formed on a rear face of the base member, the joint plate including a pair of support members which are formed on a top face thereof, the pair of the support members being spaced apart from each other by a predetermined distance, being inclined outwards in an upward direction, and being configured so that an interval therebetween is gradually increased from lower portions thereof, which are connected with the joint, to upper portions thereof.

11. The dental articulator according to claim 10, wherein:
the support members include male and female connectors at left and right upper ends thereof in a snap structure so as to be spaced apart from each other respectively, one of the connectors including a pin-shaped pivot piece, and the other connector including a recessed clamp piece into which the pivot piece is inserted; and
one of the pivot piece and the clamp piece includes a cylindrical stopper in a front thereof which has a predetermined height in an upward direction so as to prevent maxillary and mandibular articulators from being folded beyond a predetermined angle when the maxillary and mandibular articulators are coupled and occluded to each other.

12. The dental articulator according to claim 9, wherein:
the support members include male and female connectors at left and right upper ends thereof in a snap structure so as to be spaced apart from each other, one of the connectors including a pin-shaped pivot piece, and the other connector including a recessed clamp piece into which the pivot piece is inserted; and
one of the pivot piece and the clamp piece includes a cylindrical stopper in a front thereof which has a predetermined height in an upward direction so as to prevent maxillary and mandibular articulators from being folded beyond a predetermined angle when the maxillary and mandibular articulators are coupled and occluded to each other.

13. The dental articulator according to claim 8, wherein:
the support members include male and female connectors at left and right upper ends thereof in a snap structure so as to be spaced apart from each other respectively, one of the connectors including a pin-shaped pivot piece, and the other connector including a recessed clamp piece into which the pivot piece is inserted; and
one of the pivot piece and the clamp piece includes a cylindrical stopper in a front thereof which has a predetermined height in an upward direction so as to prevent maxillary and mandibular articulators from being folded beyond a predetermined angle when the maxillary and mandibular articulators are coupled and occluded to each other.

14. The dental articulator according to claim 13, wherein:
the joint plate includes an auxiliary stopper on one side of a rear end thereof, the auxiliary stopper having a height at which is allowed to come into contact with a face of the joint of a counter dental articulator so as to prevent the maxillary and mandibular articulators from being folded beyond a proper angle when occluded; and
each of the stopper and the auxiliary stopper is rounded at an upper end thereof and includes a removal notch in an outer circumference of a lower end thereof so as to be easily removed as needed.

15. The dental articulator according to claim 12, wherein:
the joint plate includes an auxiliary stopper on one side of a rear end thereof, the auxiliary stopper having a height which is such that the stopper comes into contact with a face of the joint of a counter dental articulator so as to prevent the maxillary and mandibular articulators from being folded beyond a proper angle when occluded; and
each of the stopper and the auxiliary stopper is rounded at an upper end thereof and includes a removal notch in an outer circumference of a lower end thereof so as to be easily removed as needed.

16. The dental articulator according to claim 11, wherein:
the joint plate includes an auxiliary stopper on one side of a rear end thereof, the auxiliary stopper having a height such that the stopper comes into contact with a face of the joint of a counter dental articulator so as to prevent the maxillary and mandibular articulators from being folded beyond a proper angle when occluded; and
each of the stopper and the auxiliary stopper is rounded at an upper end thereof and includes a removal notch in an outer circumference of a lower end thereof so as to be easily removed as needed.

17. The dental articulator according to claim 16, wherein the connectors protrude outwardly from the upper ends of the respective support members beyond bodies of the support members, and the clamp piece of the female connector includes a slit formed in an inner circumference thereof so as to permit elastic movement of the clamp piece.

18. The dental articulator according to claim 15, wherein the connectors protrude outwardly from the upper ends of the respective support members beyond bodies of the support members, and the clamp piece of the female connector includes a slit formed in an inner circumference thereof so as to permit elastic movement of the clamp piece.

19. The dental articulator according to claim 14, wherein the connectors protrude outwardly from the upper ends of the respective support members beyond bodies of the support members, and the clamp piece of the female connector includes a slit formed in an inner circumference thereof so as to permit elastic movement of the clamp piece.

20. A dental model fixing pin used for a dental articulator, comprising a head that includes a knurled anti-skid portion on an outer circumference of an upper end of the dental model fixing pin so as to be firmly coupled to a bottom face of a plaster dental model placed on a top face of a base member, and a body that extends from a lower end of the head so as to have a cross section and a length greater than those of the head, has a tapered shape in which a cross-sectional width thereof is gradually reduced from an upper portion thereof to a lower portion thereof, and is fitted into a pin fixing hole.

21. The dental model fixing pin according to claim 20, wherein the body includes vertical cut portions that are cut to a predetermined depth on opposite sides thereof and has the same vertical face in a downward direction, and curved round portions on opposite sides thereof in a direction perpendicular to the vertical cut portions.

22. The dental model fixing pin according to claim 21, further comprising a step portion that is formed between the head and the body so that an upper end thereof is caught on a top face of the pin fixing hole after the body is inserted into the pin fixing hole.

23. The dental model fixing pin according to claim 22, wherein the body has a length that is somewhat greater than a depth of the pin fixing hole and is somewhat smaller than a height of each sidewall of the base member, and is configured so that a lower end thereof is partially exposed to the outside of the lower end of the pin fixing hole when inserted into the pin fixing hole.
